(19) United States
(12) Patent Application Publication
(10) Pub. No.: US 2008/0066021 A1
(43) Pub. Date: Mar. 13, 2008

(54) Method of optimal parameter adjustment and system thereof

(75) Inventors: Hung-Lun Chien, Taipei County (TW); De-Yu Kao, Taipei City (TW)

Correspondence Address: BIRCH STEWART KOLASCH & BIRCH, PO BOX 747, FALLS CHURCH, VA, 22040-0747, US

(73) Assignee: Princeton Technology Corporation

(21) Appl. No.: 11/635,654

(22) Filed: Dec. 8, 2006

(30) Foreign Application Priority Data
Sep. 11, 2006 (TW) 095133448

(51) Int. Cl. G06F 17/50

(52) U.S. Cl. 716/2

(57) ABSTRACT

A method of optimal parameter adjustment includes randomly generating a first parameter group, setting each parameter into a device to detect a fitness function value corresponding to each parameter, copying parameters according to the fitness function value to form a second parameter group, randomly selecting parameter pairs from the second parameter group to implement a crossover method generating new parameter pairs to replace parameter pairs to form a third parameter group, and setting the third parameter group into the device to detect the fitness function value corresponding to each parameter and determining an optimal parameter according to the fitness function value.

### BACKGROUND OF THE INVENTION

1. Field of the Invention

The invention relates to parameter adjustment, and, in particular to a method of optimal parameter adjustment for nonlinear devices.

2. Description of the Related Art

Conventional circuit analysis is often looking for the transfer function of circuits. In Laplace transfer domain or Z transfer domain, an output signal is the product of an input signal and a transfer function. If input signals and the transfer function of circuits are provided, the output signals of the circuits can be obtained. In addition, circuit designers can also adjust each parameter of the transfer function to achieve the required circuit.

There are two kinds of circuits, a linear circuit and a nonlinear circuit. If a circuit is linear, circuit designers can use the linear system analysis to acquire the transfer function of the linear circuit to adjust parameters thereof. However, if a circuit is nonlinear, circuit designers can not use a single transfer function for representation thereof and thus linear system analysis cannot be used to adjust the parameters.

### BRIEF SUMMARY OF THE INVENTION

Accordingly, the invention provides a method of optimal parameter adjustment comprising randomly generating a first parameter group, the first parameter group comprising a plurality of parameters, setting each parameter into a device to detect a fitness function value corresponding to each parameter, copying the parameter to form a second parameter group according to the fitness function value, randomly selecting parameter pairs from the second parameter group to implement a crossover method generating new parameter pairs to replace the parameter pairs to form a third parameter group and setting the third parameter group into the device to detect the fitness function value corresponding to each parameter and determining an optimal parameter according to the fitness function value.

In addition, the invention provides another method of optimal parameter adjustment comprising randomly generating a first parameter group comprising a plurality of parameters, setting each parameter into a device to detect a fitness function value corresponding to each parameter, copying the parameter corresponding to the fitness function value to form a second parameter group if the fitness function value exceeds a critical value, randomly selecting parameter pairs from the second parameter group to implement a crossover method generating new parameter pairs to replace the parameter pairs to form a third parameter group and setting the third parameter group into the device to detect the fitness function value corresponding to each parameter and repeating the above steps a predetermined number of times to decide an optimal parameter corresponding to the fitness function value which exceeds a predetermined value.

In addition, the invention provides a system of optimal parameter adjustment comprising a device generating an output signal according to a plurality of parameters and an input signal, a detection device detecting the output signal and the input signal to generate a fitness function value and a parameter adjustment device generating the parameters and the input signal and receiving the fitness function value. The parameter adjustment device randomly generates a first parameter group comprising a plurality of parameters and sets each parameter into the device. The detection device detects the fitness function value corresponding to each parameter and transmits the fitness function value to the parameter adjustment device. The parameter adjustment device copies the parameter corresponding to the fitness function value to form a second parameter group if the fitness function exceeds a critical value. The parameter adjustment device randomly selects parameter pairs from the second parameter group to implement a crossover method generating new parameter pairs to replace the parameter pairs to form a third parameter group. The parameter adjustment device sets the third parameter group into the device. The detection device detects the fitness function value corresponding to each parameter to decide an optimal parameter corresponding to the fitness function value which exceeds a predetermined value.

### BRIEF DESCRIPTION OF THE DRAWINGS

The invention can be more fully understood by reading the subsequent detailed description and examples with references made to the accompanying drawings, wherein:

FIG. 1 shows a system of optimal parameter adjustment 100 according to an embodiment of the invention;

FIG. 2 shows a sigma-delta nonlinear device 200 according to an embodiment of the invention; and

FIG. 3 is a flowchart of a method of optimal parameter adjustment according to an embodiment of the invention.

### DETAILED DESCRIPTION OF THE INVENTION

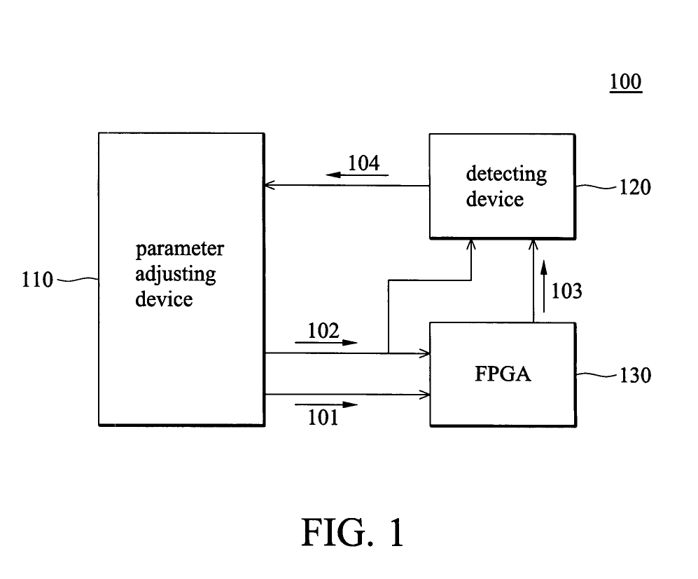

FIG. 1 shows a system of optimal parameter adjustment 100 according to an embodiment of the invention, comprising parameter adjustment device 110, detection device 120 and FPGA (Field Programmable Gate Array) 130. FPGA 130 can be linear or nonlinear. Parameter adjustment device 110 provides parameters 101 and input signal 102 to FPGA 130. Detection device 120 detects input signal 102 and output signal 103 to generate fitness function value 104. In an embodiment of the invention, FPGA 130 can be programmed as a sigma-delta (Σ-Δ) nonlinear device and fitness function value 104 can be a SNR (signal to noise ratio) value. Detection device 120 detects input signal 102 and output signal 103 to generate a SNR value.

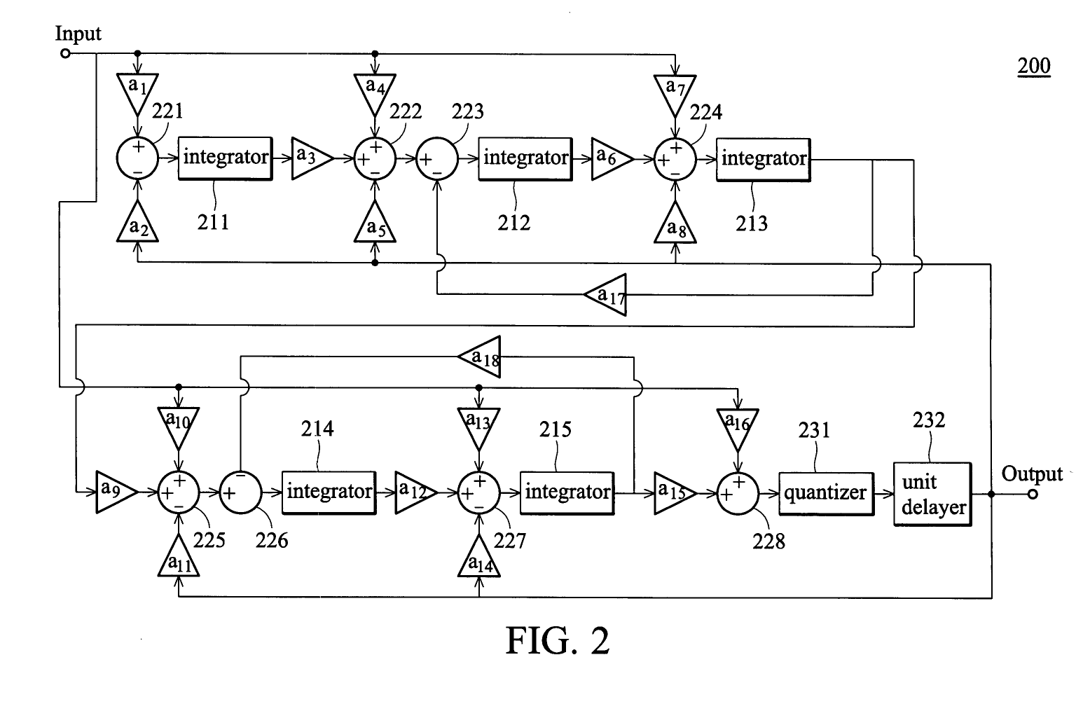

FIG. 2 shows a sigma-delta nonlinear device 200 according to an embodiment of the invention. Sigma-delta nonlinear device 200 comprises integrator (211˜215), amplifiers (a1˜a18), adder (221˜228), quantizer 231 and unit delayer 232. Since quantizer 231 is a nonlinear device, circuit designers can not use the linear system analyzing method to acquire the transfer function (output/input) of sigma-delta nonlinear device 200. However, circuit designers can use the optimal adjusting parameter method of the invention to acquire optimal parameters of sigma-delta nonlinear device 200.

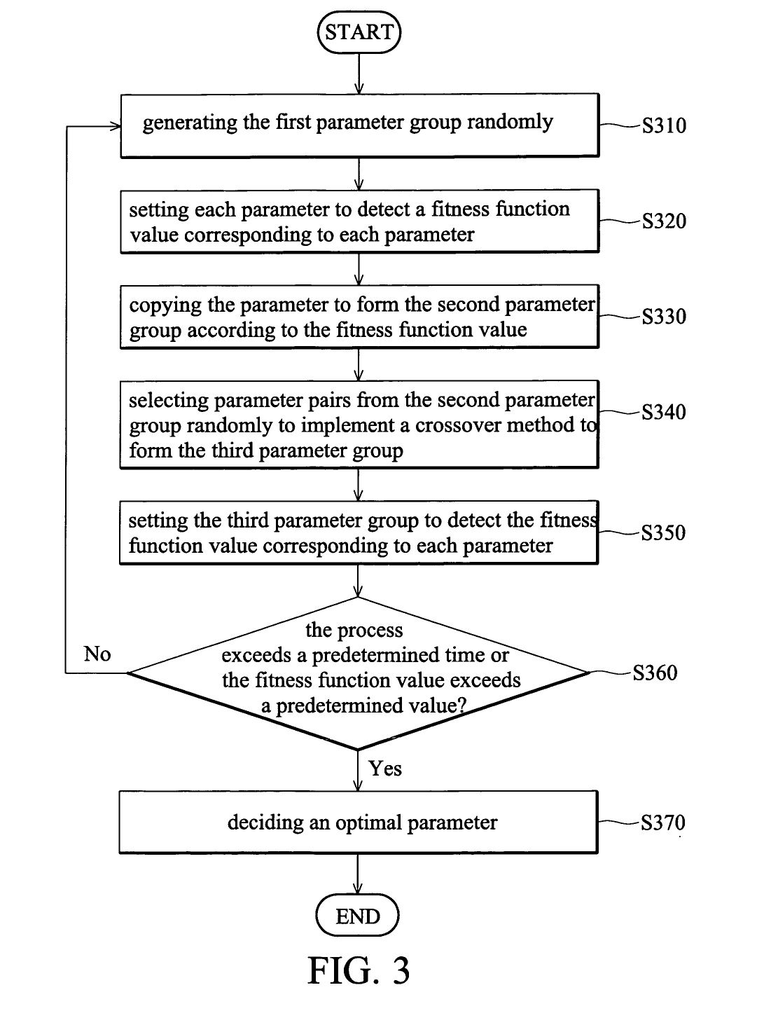

FIG. 3 is a flowchart of a method of optimal parameter adjustment according to an embodiment of the invention. Please referring to FIGS. 1 and 2 simultaneously, FPGA 130 is programmed as sigma-delta nonlinear device 200. First, Parameter adjustment device 110 randomly generates a plurality of parameters to form a first parameter group (S310). Parameter adjustment device 110 further presets initial parameters and randomly generates parameters of the first parameter group near the initial parameters. Next, parameter adjustment device 110 sets each parameter into sigma-delta nonlinear device 200. Detection device 120 detects FPGA 130 to acquire fitness function value 104 corresponding to each parameter and transmits fitness function value 104 to parameter adjustment device 110 (S320). If the fitness function value 104 exceeds a critical value, parameter adjustment device 110 copies the parameter corresponding to the fitness function value 104 to form a second parameter group. The second parameter group comprises the copying parameters and original parameters (S330). Next, parameter adjustment device 110 randomly selects parameter pairs from the second parameter group to implement a crossover method generating new parameter pairs to replace the previously selected parameter pairs to form a third parameter group. The third parameter group comprises new parameter pairs and original parameters but not the previously selected parameter pairs (S340). The crossover method can utilize one-point crossover or two-point crossover method. If one-point crossover is used, if parameter P is 00101111, parameter q is

11010001 and the cross-point is 4, the new parameter P′ is 00100001 and new parameter q′ is 11011111. With a two-point crossover method, if parameter A is 101010101, parameter B is 000001111 and the cross-points are 3 and 6, new parameter A′ is 000010111 and new parameter B′ is 101001101. Parameter adjustment device 110 sets the third parameter into sigma-delta nonlinear device 200. Detection device 120 detects the fitness function value corresponding to each parameter (S350). If the process exceeds a predetermined number of times or the fitness function value exceeds a predetermined value (S360), parameter adjustment device 110 determines an optimal parameter (S370). If not, step S310 is repeated.

In addition, between step S310 and step S350, parameter adjustment device 110 may mutate partial parameters of the first parameter group, the second parameter group and the third parameter group according to a predetermined mutation probability. Furthermore, between step S310 and step S350, partial or all parameters of the first parameter group, the second parameter group and the third parameter group are further replaced by predetermining parameters.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of optimal parameter adjustment, comprising:
(a) randomly generating a first parameter group comprising a plurality of parameters;
(b) setting each parameter into a device to detect a fitness function value corresponding to each parameter;
(c) copying the parameter to form a second parameter group according to the fitness function value;
(d) randomly selecting parameter pairs from the second parameter group to implement a crossover method generating new parameter pairs to replace the parameter pairs to form a third parameter group; and
(e) setting the third parameter group into the device to detect the fitness function value corresponding to each parameter and determining an optimal parameter according to the fitness function value.

2. The method of optimal parameter adjustment as claimed in claim 1, wherein the step of (a) further presets initial parameters and randomly generates the first parameter group near the initial parameters.

3. The method of optimal parameter adjustment as claimed in claim 1, wherein the step of (c) further copies parameters corresponding to the fitness function value if the fitness function exceeds a critical value.

4. The method of optimal parameter adjustment as claimed in claim 1, wherein the step of (e) further acquires the optimal parameter corresponding to the fitness function value which exceeds a predetermined value.

5. The method of optimal parameter adjustment as claimed in claim 1, further repeating the steps (b)˜(e) a predetermining number of times to acquire the optimal parameter corresponding to the fitness function value which exceeds a predetermined value.

6. The method of optimal parameter adjustment as claimed in claim 1, further mutating partial parameters of the first parameter group, the second parameter group and the third parameter group randomly according to a predetermined mutation probability.

7. The method of optimal parameter adjustment as claimed in claim 1, wherein the device is a field programmable gate array or a sigma-delta (Σ-Δ) nonlinear device.

8. The method of optimal parameter adjustment as claimed in claim 1, wherein the fitness function value is a SNR (signal to noise ratio) value, and the crossover method is one-point or two-point crossover method.

9. The method of optimal parameter adjustment as claimed in claim 1, wherein partial parameters of the first parameter group, the second parameter group and the third parameter group are replaced by predetermined parameters.

10. A method of optimal parameter adjustment, comprising:
(a) randomly generating a first parameter group comprising a plurality of parameters;
(b) setting each parameter into a device to detect a fitness function value corresponding to each parameter;
(c) copying the parameter corresponding to the fitness function value to form a second parameter group if the fitness function value exceeds a critical value;
(d) randomly selecting parameter pairs from the second parameter group to implement a crossover method generating new parameter pairs to replace the parameter pairs to form a third parameter group; and
(e) setting the third parameter group into the device to detect the fitness function value corresponding to each parameter and repeating the steps (b)˜(e) a predetermined number of times to acquire an optimal parameter corresponding to the fitness function value which exceeds a predetermined value.

11. The method of optimal parameter adjustment as claimed in claim 10, further mutating partial parameters of the first parameter group, the second parameter group and the third parameter group randomly according to a predetermined mutation probability.

12. The method of optimal parameter adjustment as claimed in claim 10, wherein the device is a field programmable gate array or a sigma-delta nonlinear device.

13. The method of optimal parameter adjustment as claimed in claim 10, wherein the fitness function value is a SNR value, and the crossover method is one-point or two-point crossover method.

14. The method of optimal parameter adjustment as claimed in claim 10, wherein partial parameters of the first parameter group, the second parameter group and the third parameter group are replaced by predetermined parameters.

15. An system of optimal parameter adjustment, comprising:
a device generating an output signal according to a plurality of parameters and an input signal;
a detection device detecting the output signal and the input signal to generate a fitness function value; and
a parameter adjustment device generating the parameters and the input signal and receiving the fitness function value;
wherein the parameter adjustment device randomly generates a first parameter group comprising a plurality of parameters and sets each parameter into the device, the detection device detects the fitness function value corresponding to each parameter and transmits the fitness function value to the parameter adjustment device, the parameter adjustment device copies the parameter corresponding to the fitness function value to form a second parameter group if the fitness function exceeds a critical value, the parameter adjustment device randomly selects parameter pairs from the second parameter group to implement a crossover method generating new parameter pairs to replace the parameter pairs to form a third parameter group, the parameter adjustment device sets the third parameter group into the device and the detection device detects the fitness function value corresponding to each parameter to acquire an optimal parameter corresponding to the fitness function value which exceeds a predetermined value.

16. The system of optimal parameter adjustment as claimed in claim 15, wherein the device is a field programmable gate array or a sigma-delta nonlinear device.

17. The system of optimal parameter adjustment as claimed in claim 15, wherein the fitness function value is a SNR value, and the crossover method is one-point or two-point crossover method.

18. The system of optimal parameter adjustment as claimed in claim 15, wherein the parameter adjustment device further presets initial parameters and randomly generates the first parameter group near the initial parameters.

19. The system of optimal parameter adjustment as claimed in claim 15, wherein the parameter adjustment device randomly mutates partial parameters of the first parameter group, the second parameter group and the third parameter group according to a predetermined mutation probability.

20. The system of optimal parameter adjustment as claimed in claim 15, wherein the parameter adjustment device replaces partial parameters of the first parameter group, the second parameter group and the third parameter group with predetermined parameters.
